(19) United States
(12) Patent Application Publication
(10) Pub. No.: US 2005/0012814 A1
(43) Pub. Date: Jan. 20, 2005

(54) Method for displaying multiple-view stereoscopic images

(76) Inventor: Hsiao-Pen Shen, Taipei (TW)

Correspondence Address: BIRCH STEWART KOLASCH & BIRCH, PO BOX 747, FALLS CHURCH, VA, 22040-0747, US

(21) Appl. No.: 10/620,694

(22) Filed: Jul. 17, 2003

(51) Int. Cl. H04N 13/00

(52) U.S. Cl. 348/51; 348/42

(57) ABSTRACT

A method for displaying multiple-view auto-stereoscopic images without using stereoscopic glasses is disclosed in the invention. The multiple-view stereoscopic images are directly sent to the stereoscopic image synthesizer (or a software simulated by computer), and after the synthesizer has been informed about the view number and the horizontal and vertical display resolutions of the screen, the stereoscopic image synthesizing processing can be performed. Finally, the synthesized result will be displayed on the flat panel display. With the laminated lenticular lens vertically slanted at an angle of about 9.4623 degrees the viewer can watch the stereoscopic images on the display without wearing stereoscopic glasses.

### FIELD OF THE INVENTION

The invention relates to a method for displaying auto-stereoscopic images and, more particularly, to a multiple-view stereoscopic image displaying method that arranges image separation for multiple-view images and informs the stereoscopic image synthesizer to synthesize the separated images into an interweaved multiple-view image format suitable to be displayed on the lenticular lens so that a user can watch stereoscopic images on a flat panel display (such as an LCD monitor) that is provided with lenticular lens, without wearing stereoscopic glasses.

### BACKGROUND OF THE INVENTION

The human ability in stereoscopic vision is that each of the two eyes can view the same scene but report to the optical nervous system with binocular disparity generated by two eyes. For years, the binocular disparity has been applied in the stereoscopic LC shutter glasses for viewing a stereoscopic image in a personal computer environment. In other words, the left eye and the right eye are displaying images by means of image alternation when viewing an interlaced scanning in accordance with vertical synchronous signals controlled by a screen. Basically, the binocular disparity is a result caused by placing the even-numbered lines of the scanning lines in the left-eye image (or right-eye image) and placing the odd-numbered lines of the scanning lines in the right-eye image (or the left-eye image), and then through the alternate display made by the two eyes, the left eye of the viewer can only see a left-eye image when the screen is displaying the even-numbered lines. At the same time, the LC shutter glasses will automatically block vision in the right eye in accordance with the interlaced displaying method. By the same token, when the screen is displaying the odd-numbered lines, the right eye can only see a right-eye image because the LC shutter glasses will automatically block vision in the left eye in accordance with the interlaced displaying method. By doing so, the image in each eye will be sent to the two eyes separately, and the speed of sending is faster than that of the persistence of vision of a person. Thus, through the repeating alternate display, a person is able to view stereo 3D images.

As mentioned above, a viewer has to wear stereoscopic glasses when watching two-view stereoscopic images. However, wearing stereoscopic glasses can often cause uncomfortable feeling to a viewer, especially to a near-sighted viewer, who might have problem handling another glasses besides his/her own near-sighted glasses. In such circumstances, it is imperative for a viewer to have an alternative that he/she can view the stereoscopic images without wearing stereoscopic glasses. So far, the most economical technique to view stereoscopic images is to apply a multiple-view stereoscopic image displaying method with lenticular lens, which is also frequently and widely used in printing products such as stationary, gifts, toys, and packaging materials. Although the multiple-view stereoscopic image displaying method with lenticular lens is a conventional technique that has been used for many years, the technique has been improved by adopting new technology. For instance, a light-and-slim flat panel display such as an LCD monitor has been introduced for replacing the traditional clumsy CRT display. To follow suit, the stereoscopic image display will also switch to the LCD monitor as well. Under such circumstances, what should be shown in an LCD monitor are not just still images; rather than that, interactive real-time stereoscopic images of multi-media animations and still images will be displayed. However, the interactive stereoscopic images processed in real-time require a technique that can synthesize multiple-view stereoscopic images, which will also take a lot of processing time in computer, especially when multiple-view stereoscopic image synthesizing with super resolution is involved. Therefore, it is necessary to assign the synthesizing job to a dedicated hardware or software synthesizer to enhance the effectiveness of computer work.

### SUMMARY OF THE INVENTION

To solve the aforementioned problem caused by wearing conventional stereoscopic glasses when watching stereoscopic images, the object of the invention is to provide a method for displaying multiple-view stereoscopic images so that a viewer can see stereoscopic images of high effect, high quality, and non-distortion on the screen without wearing stereoscopic glasses, and the working performance of the computer can be enhanced as well.

In order to achieve the above-mentioned object, the multiple-view stereoscopic images will be directly transmitted to the stereoscopic image synthesizer simulated by the computer software, and then the synthesizer will be informed about the view number and the horizontal and vertical display resolutions of the screen. After that, stereoscopic image synthesizing processing will be performed, and a synthesized result will be displayed on a flat panel display, and finally an appropriate lens is put on the synthesized result. Thus, a viewer can see stereoscopic images on the display without wearing stereoscopic glasses.

### BRIEF DESCRIPTION OF THE DRAWINGS

FIG. 1 is a flow chart showing the method for displaying stereoscopic images of the invention.

FIG. 2 is a schematic diagram showing the blocks contained in the flat panel display of the invention.

FIG. 3 is a schematic diagram showing the structure of the blocks of the invention.

FIG. 4 is a schematic diagram showing the lenticular lens of the invention is slanted at an angle θ.

FIGS. 5A to 5C are illustrating processing algorithm executed by the R, G and B sub-pixels of the stereoscopic image synthesizer of the invention.

### DETAILED DESCRIPTION OF THE PREFERRED EMBODIMENTS

The objects and technical contents of the invention will be described in detail in the following embodiment with reference to the drawings.

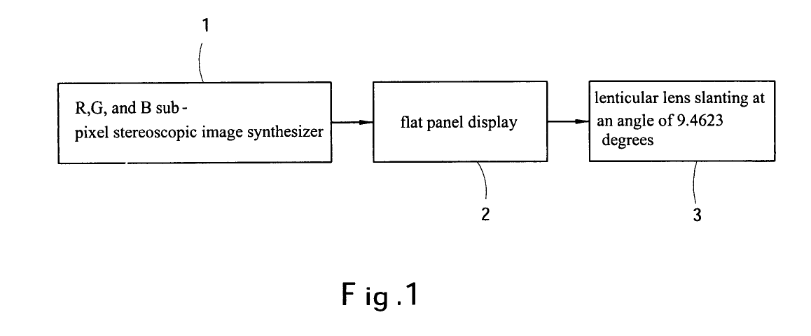

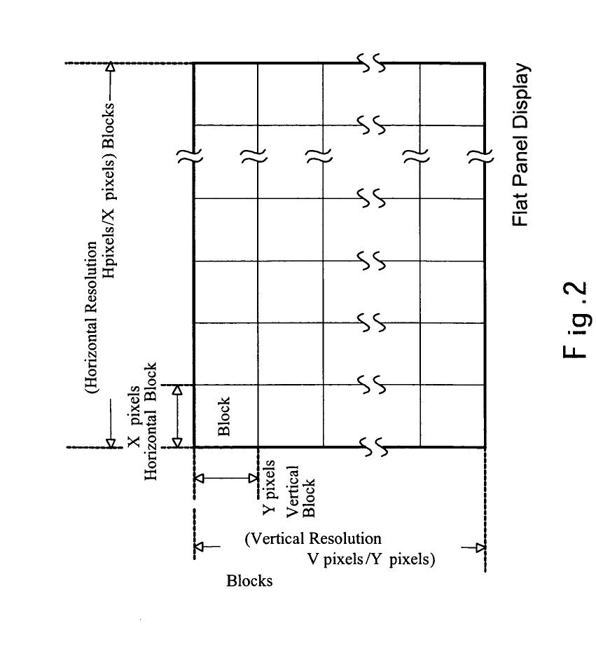

FIG. 1 is a flow chart showing the method for displaying stereoscopic images of the invention. Referring to FIG. 1, the method for displaying multiple-view stereoscopic images of the invention first includes a stereoscopic image synthesizer 1, a flat panel display 2, and a lenticular lens 3. After the multiple-view images have been obtained, the images will be directly transmitted to the stereoscopic image synthesizer 1 simulated by the computer software, and then the synthesizer 1 will be informed about the view number and the horizontal and vertical display resolutions of the screen. After that, a synthesizing processing for the stereoscopic images will be performed, and a synthesized result will be displayed on the flat panel display Z and finally the lenticular lens 3 is put on the synthesized result. Thus, a viewer can see stereoscopic images without wearing stereoscopic glasses.

The following will describe the processing procedures of the invention.

First, to obtain multiple-view stereoscopic images, one or more than one photographic device (such as a digital camera or a camera simulated by a computer) can be utilized to take images at different angles, wherein the multiple-view images should be taken on the same plane through a straight-line path (or an orbital path) by the photographic device at different angles, and the lens of the photographic device can be placed either in parallel to or in convergence on the target.

Next, after the multiple-view stereoscopic images have been obtained, the images will be directly sent to the stereoscopic image synthesizer 1 simulated by the computer software or hardware processor. Then, the synthesizer 1 will be informed about the resolution (i.e. horizontal H pixels and vertical Y pixels) and the columns (X) and rows (Y) of the view arrangement according to the resolution of the flat panel display 2. Then, the view number and each view size of the multiple-view images can be calculated out, and a horizontal screen will be segmented into column blocks of horizontal resolution, whereas a vertical screen will be segmented into row blocks of vertical resolution. Therefore, each block (X×Y pixels) of flat panel display 2 will be mapped to the pixels at the corresponding locations of each image (i.e. each view) separated from the multiple-view stereoscopic images. In other words, for instance, there is a display of 1024×768 pixels. It can be divided into 9 views in “3 Rows×3 Columns”. Then each view would be (1024/3)×(768/3) pixels, i.e. “341×256 pixels”. And, the display will be constructed by 341×256 “Blocks” accordingly. Each block will be mapped to the pixels at the corresponding locations of each view. It means that the pixels of each block would be actually synthesized from the pixels at the corresponding locations of each view. Specifically, the basic unit of each auto-stereoscopic image of the invention is a “block”, whereas the basic unit of the block is synthesized or interweaved by the corresponding pixels of each view image.

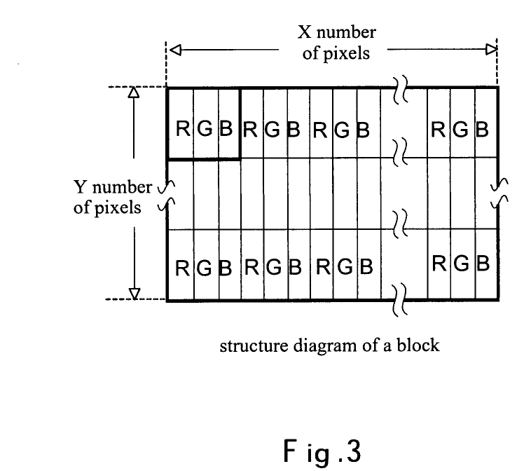

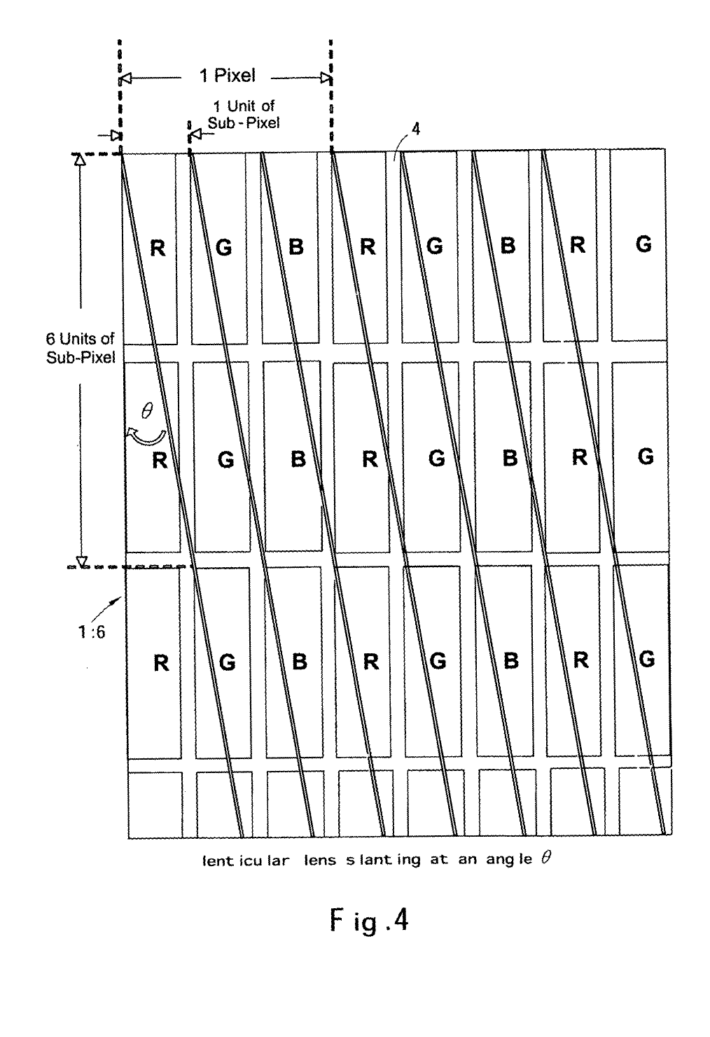

Also, as shown in FIG. 3, each pixel of the flat panel display 2 is composed of three sub-pixels, including Red sub-pixel (R), Green sub-pixel (G), and Blue sub-pixel (B). Also, there are black matrixes between the sub-pixels so as to isolate the emitting of the R, G, B sub-pixels for flat panel display like LCD monitor. If the lenticular lens 3 is put on the display screen in parallel to the R, G, B sub-pixels, a serious optical “Morie Effect” will be resulted in because of the black matrixes. However, the problem of “Morie Effect” can be eliminated if the lenticular lens 3 is slanted at an angle θ of about 9.4623 degrees. The reason for the slanting is that the vertical length of each sub-pixel is three times as much as the horizontal length of the sub-pixel for the flat panel display; therefore, two sub-pixels must be across before the black matrixes 4 can be blocked. For this reason, if the angle slanting can be done by applying the trigonometric function tan θ=1/6, the black matrixes 4 can then be blocked. Thus, according to the function, the value of θ can be obtained by inversing the tangent; that is, θ=tan⁻¹ ⅙=9.4623 degrees. As shown in FIG. 4, after the angle slanting, the black matrixes can be blocked, and thus the “Morie Effect” can be resolved. However, in order to comply with the angle slanting made by the lenticular lens 3, each pixel of each view image inside the blocks has to be rearranged corresponding to the slanting angle, while the rearrangement must be based on the R, G, B sub-pixels. Therefore, the stereoscopic image synthesizer of the invention can be a hardware processor or a software simulator, whose function is to support the synthesizing with the arrangement based on R, G, B sub-pixels.

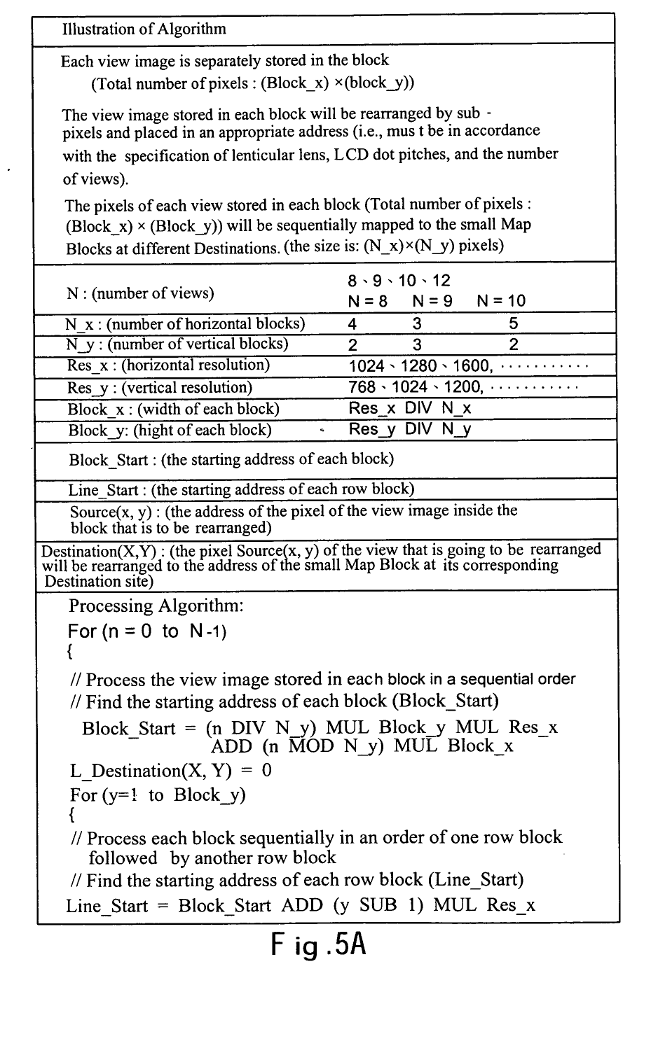

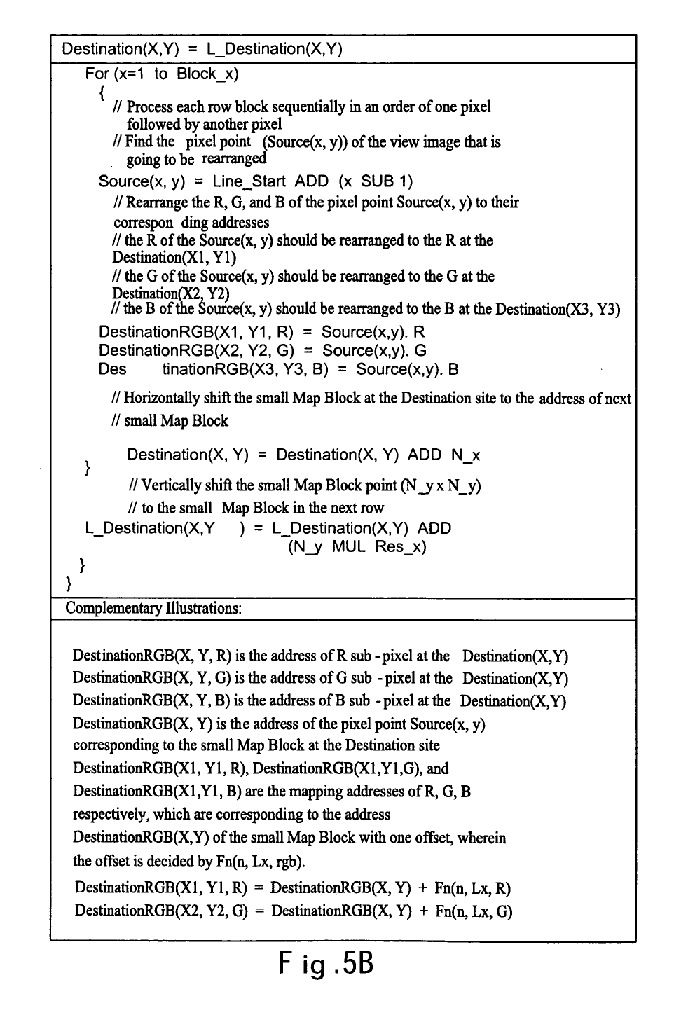

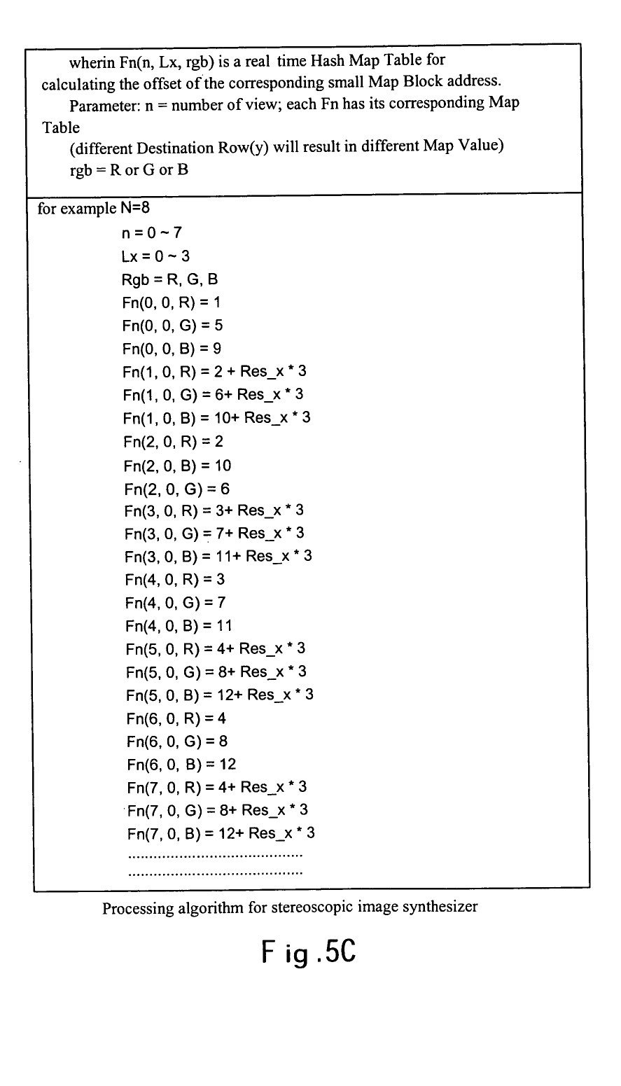

As for the synthesizing method, please refer to the processing algorithm shown in FIGS. 5A, 5B and 5C. By applying the processing algorithm, it can be determined that how many images a multiple-view stereoscopic scene can be separated into, how the separated images should be arranged, and how the synthesizing method of R, G, B sub-pixels should be applied so that the separated images can be synthesized into a stereoscopic image. After that, the stereoscopic image can be displayed on the flat panel display 2, and through the assistance of lenticular lens 3 slanted at an angle of 9.4623 degrees and put on the flat panel display 2, the viewer can watch stereoscopic images displayed on the flat panel display 2 without wearing stereoscopic glasses.

1. A method for displaying multiple-view stereoscopic images, including the following steps:
A) obtaining a set of multiple-view images;
B) sending the multiple-view images to the stereoscopic image synthesizer and, then informing the view number of the multiple-view images and the horizontal display resolution and the vertical display resolution of the screen by the stereoscopic image synthesizer after finishing step A; and
C) forming the stereoscopic images displayed on the flat panel display with a lenticular lens slanted at an angle after completing step B.

2. The method for displaying multiple-view stereoscopic images as claimed in claim 1, wherein one or more than one photographic device (such as a digital camera or a camera simulated by a computer) can be utilized to take the multiple-view stereoscopic images at different angles, and the stereoscopic images should be taken on the same plane through a straight-line path (or an orbital path) by the photographic device at different angles, and the lens of the photographic device can be placed either in parallel to or in convergence on the target.

3. The method for displaying multiple-view stereoscopic images as claimed in claim 1, wherein the stereoscopic image synthesizer is using the R, G, B sub-pixels for synthesizing the stereoscopic images so as to replace the conventional stereoscopic image synthesizing method that is using pixel as an unit, and a processing algorithm for synthesizing the stereoscopic images is applied to execute the stereoscopic image synthesizing.

4. The method for displaying multiple-view stereoscopic images as claimed in claim 1, wherein a lenticular lens is vertically installed or laminated to the screen of the flat panel display, while the lenticular lens is slanted at an angle of about 9.4623 degrees.
